(19) United States
(12) Patent Application Publication
(10) Pub. No.: US 2004/0069817 A1
(43) Pub. Date: Apr. 15, 2004

(54) Hand pump foamer

(76) Inventor: Daniel R. Jacques, Caledonia, MI (US)

Correspondence Address: DANIEL R. JACQUES, 900 Fifth Third Center, 111 Loyon Street, N.W., Grand Rapids, MI, 49503-2487, US

(21) Appl. No.: 10/647,362

(22) Filed: Aug. 25, 2003

Related U.S. Application Data
(60) Provisional application No. 60/418,505, filed on Oct. 15, 2002.

(51) Int. Cl. B67D 3/00

(52) U.S. Cl. 222/529

(57) ABSTRACT

A hand-operated, portable sprayer to selectively produce a foamy effluent spray, rather than only the purely liquid spray provided by conventional sprayers. The sprayer includes segregated air and liquid delivery systems that separately supply air and liquid from the pressurized tank reservoir to a mixing chamber. Foaming may be facilitated by incorporating a mixing medium in or downstream from the mixing chamber. A flow controller is provided to control the flow of output from the sprayer. The flow controller and the mixing chamber may be incorporated into a single component. A valve may be included in the air delivery line to allow the users to attenuate the air flow rate to the mixing chamber, thereby permitting the user to select the consistency of the effluent foam according to the particular application.

This application claims the benefit of U.S. Provisional Application No. 60/418,505 filed Oct. 15, 2002 and entitled “Hand Pump Foamer.”

### BACKGROUND OF THE INVENTION

The present invention relates to portable spray units, and more particularly to hand-operated sprayers capable of producing a foam spray.

Hand-operated portable spray units have a wide variety of applications. A non-exhaustive list of examples includes: agricultural (pesticides, herbicides, germicides), chemical, and janitorial (degreasers, disinfectants, carpet treatments, cleaners, etc.) applications. A portable unit has the advantage of being able to apply a given spray liquid to areas that are not easily accessible to larger, gasoline- or electricity-powered units. Hand-operated sprayers have the further advantage that they are less expensive to produce and maintain, thus allowing the technology to be applied by a wider base of users over a greater number of applications.

For some applications, it is desirable for the spray to be a foamy, heterogeneous mixture of gas and liquid, as opposed to a homogeneous liquid. Possible examples here include the application of pesticides, herbicides, cleaners, etc. There are a variety of advantages to a foamy spray. For example, the consistency of the foam is generally greater than that of a pure liquid, and will thus remain on the applied area for a longer period of time, being less likely to experience run-off. Further, the opaque foam provides a visual indicator to the user as to which areas have already been treated and which have not.

Without these properties, there a two possible negative consequences. First, the user may potentially under-apply the spray inasmuch as certain areas might receive no liquid whatsoever and/or the contact time of the liquid with the applied area might be insufficient due to run-off. An alternate possibility is that the user, in an attempt to compensate for the previous drawback, may consistently over-apply the spray. This is an economic disadvantage from the standpoint of greater product consumption, and also possibly a health and/or environmental risk if the applied chemical is hazardous.

Previous attempts to develop portable, hand-operated foaming sprayers have been made. For example, U.S. Pat. No. to 5,881,493 to Restive describes a portable, hand-operated sprayer for the particular application of treating fire ants. The Restive patent utilizes a standard portable sprayer, but uses a modified withdrawal tube to feed both the treatment liquid and air from the pressurized tank to the flow controller. More specifically, Restive includes a withdrawal tube having an open end that is submerged in the liquid and an air hole toward the top of the tank. The air hole allows pressurized air from the pressurized tank head to enter the withdrawal tube and mix with the liquid to create a foam. The flow controller has a series of mixing screens to generate a foam effluent. A limitation of this design is that it can produce a sputtering flow of variable foam composition due to an inconsistent withdrawal of air from the pressurized head and back pressure in the withdrawal tube. Further attempts to generate a foam spray utilize an aspirating head at the outlet of the spray wand. These approaches use the aspirator to entrain air in the liquid at the spray exit to generate a foam. Although requiring little modification to existing sprayers, these systems generally suffer from low expansion ratios, resulting in milky, inadequate foam for many applications. As a result of these typical limitations, there is a need for an improved, hand-operated portable sprayer that is capable of providing consistent foam flow rates of consistent composition and sufficient expansion ratios.

### SUMMARY OF THE INVENTION

The aforementioned limitations are overcome by the present invention wherein a hand-operated, portable foam spraying unit is provided with segregated withdrawal (or delivery) systems for the air and spray liquid in the pressurized tank. The unit also includes a mixing structure, defined generally as a mixing chamber. The mixing chamber is the point external to the tank at which the air and the spray liquid streams are combined to form a single multiphase flow.

In one embodiment, the spraying unit may include a control valve, such as a needle or a pinch valve, on the air delivery line to regulate the air flow rate to the mixing chamber. The control valve permits selective control over the relative volume of air mixed with the spray liquid, and, accordingly, control over the consistency of the effluent. Furthermore, the air line may be equipped with a check valve to prevent the backflow of spray liquid into the tank.

In another embodiment, the spraying unit includes a mixing medium to mix the air and liquid prior to expulsion from the unit. The mixing medium may be located in or at any point downstream from the mixing chamber.

In a further embodiment, the spraying unit may include a flow controller for selectively controlling the flow of effluent from the unit. The flow controller may be a conventional flow controller, such as a conventional, manually-actuated spray valve, which may be further attached to a spray wand and nozzle. The tank may be equipped with a pre-fabricated, manually-actuated hand pump. The hand pump allows the user to create a pressurized headspace above the fluid, which serves as the driving force for both the air and fluid streams. In one embodiment, two exit orifices are located on the top surface of the tank. One provides an exit line for pressurized air in the fluid headspace. The other allows for the exit of fluid from the tank, and therefore includes a withdrawal tube extending from the top of the tank to near the bottom of the tank. The two orifices may be accommodated by either one or two fittings on the surface of the tank.

In operation of one embodiment, air and liquid exiting from the tank travel in a segregated arrangement through separate air and liquid withdrawal systems, for example, through two separate flexible hoses. The flow rate of the air stream may be attenuated via a valve located anywhere along the length of the air line. The air and liquid withdrawal systems enter the base of the flow controller, which is configured to allow the entry of two separate feed lines. The hollow base of the flow controller serves as the mixing chamber for the two fluids, and is further adapted to the foaming application with the insertion of a fibrous mixing medium. The foam generated in the mixing chamber is released via the flow controller. It exits the sprayer through an (optional) spray wand, followed by a nozzle attachment, and is thereby applied to the desired area.

In an alternative embodiment, a Y-fitting is used to transition the flow from two single-phase streams to one multiphase stream. In this case, the air and liquid lines converge in the base of the Y-fitting (which may be therefore termed the mixing chamber). The multiphase outlet of the Y-fitting is attached to the inlet of the flow controller.

The present invention provides a simple and inexpensive improvement to portable sprayers, addressing the significant limitations of previous attempts to deliver a foam spray with such a device. The segregated withdrawal of air and liquid from the tank provides improved foam consistency in the effluent. Further, the apparatus affords the user a significant degree of control over the spray properties and offers a broader range of operating conditions. When the control valve in the air line is completely open, the apparatus produces a foam with consistency dependent upon the application-specific parameters, including: pressure drop, flow rates, spray liquid chemical composition, and mixing medium. When the needle valve is completely closed, no foam is produced and the sprayer may be used in a conventional liquid-spray mode. Variation of the needle valve setting between the two extremes allows the user to tailor the effluent foam properties to address various factors, such as the properties of the liquid chemical composition and the personal preference. This element of control also has the effect of providing a non-sputtering effluent with a nearly constant flow rate. Further, the straight-through design of the flow controller fosters a low-shear environment, which is therefore less likely to break up the foam bubbles, thereby increasing the lifetime of the resultant foam.

These and other objects, advantages, and features of the invention will be readily understood and appreciated by reference to the detailed description of the preferred embodiment and the drawings.

### BRIEF DESCRIPTION OF THE DRAWINGS

FIG. 1 is a perspective view of a hand-operated, portable sprayer in accordance with the preferred embodiment of the present invention;

FIG. 2 is a cross sectional view of a hand-operated, portable sprayer in accordance with the preferred embodiment of the present invention;

FIG. 3 is a cross sectional view of a hand-operated, portable sprayer in accordance with an alternative embodiment of the present invention;

FIG. 4a is an enlarged, exploded, perspective view of the segregated, side-by-side fluid transfer lines at the entry to the base of the flow controller;

FIG. 4b is an enlarged, exploded, perspective view of the segregated, Y-fitting fluid transfer lines at the entry to the base of the flow controller;

FIG. 5a is an enlarged, cross sectional view of the flow controller of FIG. 2; and

FIG. 5b is an enlarged, cross sectional view of the flow controller of FIG. 3.

### DETAILED DESCRIPTION OF THE PREFERRED EMBODIMENTS

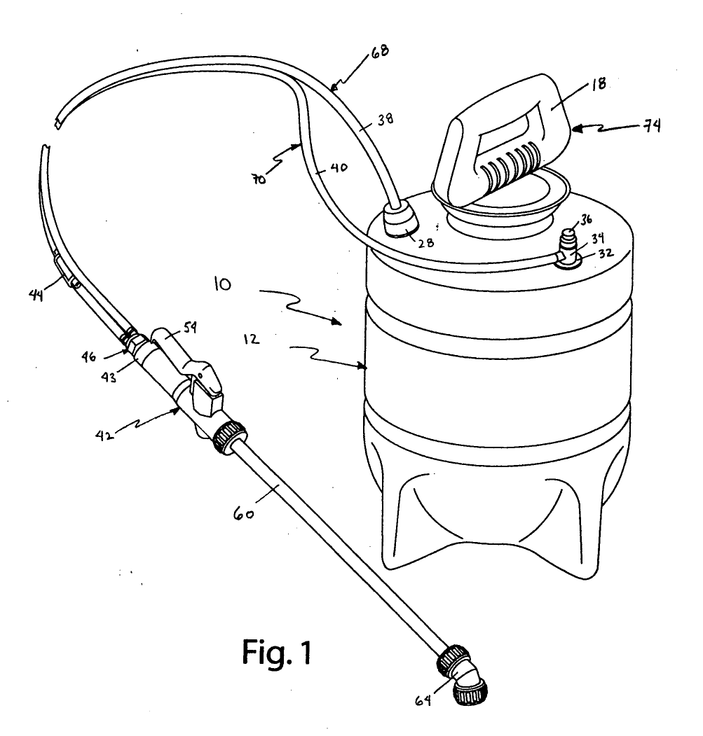

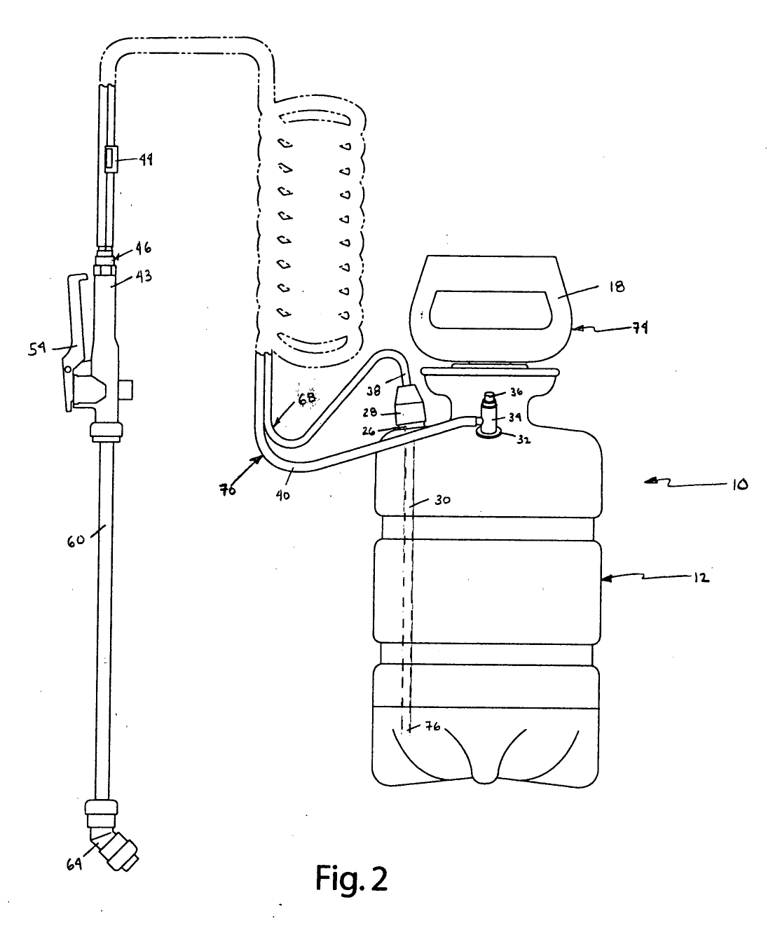

A hand-operated, portable sprayer capable of producing a foam spray according to a preferred embodiment of the present invention is shown in FIGS. 1 and 2, and is designated generally as 10. The sprayer 10 generally includes a tank 12 for holding the liquid to be sprayed, a pump 74 for pressurizing the tank 12, a liquid delivery system 68 for withdrawing liquid from the tank 12, an air delivery system 70 for withdrawing air from the headspace in the tank 12, a mixing chamber 72 for combining the air and liquid separately withdrawn from the tank 12, and a flow controller 42 for regulating the flow of effluent from the sprayer 10. In operation of the preferred embodiment, the pump 74 is operated to pressurize the interior of the tank 12. This pressurizes the liquid in the tank 12 and the air in the headspace above the liquid. The air and liquid are separately withdrawn from the tank 12 and combined in the mixing chamber 72 to create a foam that is selectively discharged from the sprayer 10 by the flow controller 42. The present invention is described in connection with a preferred embodiment having a commercially-available sprayer that is inexpensively modified according to the specifications herein. The present invention is easily and inexpensively incorporated into a wide variety of commercially available sprayers, including, without limitation, the RL Flo-Master®, Models 1960, 1970, 1990A, 1990VI, and 2602VI, manufactured by Root-Lowell Manufacturing Co., Lowell, Mich. Although the present invention is described in connection with a modified commercially available sprayer, the present invention may alternatively be based on a custom-designed sprayer.

As noted above, sprayer 10 includes a generally conventional sprayer. The sprayer 10 includes a 2-gallon component tank 12 that is constructed from high density polyethylene (HDPE). HPDE is generally resistant to degradation by a wide variety of chemicals. Depending upon the particular intended use, however, the construction material and capacity of the tank may be varied as appropriate. For instance, the pressurized tank may be composed of stainless steel in order to be more resilient to particularly corrosive chemicals. Similarly, tank volumes in the range of 1 to 5 gallons are still small enough to be portable, yet large enough to hold sufficient liquid for typical spraying applications, eliminating an overly-frequent need to refill the tank. Although this range of tank volumes is typical, the present invention extends to tank volumes outside of this range.

The sprayer 10 includes a pump for pressurizing the tank 12. Any of a wide variety of pumps may be incorporated into the present invention. In the illustrated embodiment, the sprayer 10 includes a hand-operated reciprocating pump 74 that is inserted into the tank 12 in an air-tight configuration. This particular pump is pre-fabricated and is available from a variety of sources, such as Root-Lowell Manufacturing Co., Lowell, Mich. The pump 74 generally includes a pump piston (not shown) and handle 18 that are inserted into a pump cylinder (not shown). These components are held in place via a pump cylinder gasket (not shown). The pump 74 also includes a plunger U-cup seal (not shown) affixed to the base of the piston (not shown) and a check valve (not shown) that is inserted into the base of the pump cylinder (not shown). During the piston upstroke, a partial vacuum draws air into the pump cylinder (not shown). During the downward stroke, the air in the pump cylinder (not shown) is compressed and then expelled through the check valve (not shown), creating a buildup of pressure in the headspace of tank 12. This process is repeated until the pressure head reaches its desired operating value, typically in the range of 20 to 30 psi. As noted above, the present invention is not limited to sprayers 10 with hand-operated pumps. Alternative pumps may be used. For example, the present invention may include an electric pump, a compressed air canister, or another conventional source of compressed air.

The sprayer 10 may also include one or more of a variety of conventional accessories. For example, in some applications, the tank 12 may include an orifice (not shown) designed to accommodate an external feed line to facilitate filling of the tank 12. As a more specific example, the tank 12 may include an attachment fitting (not shown) for a conventional garden hose fitted through the wall of the tank 12. This would facilitate the safe, rapid filling of the reservoir, in particular when the spray fluid is a solution composed primarily of water. If desired, the tank 12 may also be fitted with a pressure relief valve (not shown). Because a significant pressure head may be left in the tank after the completion of its use, it may be desirable to release the pressure prior to tank storage and/or emptying. The valve permits the release of excess pressure in a safe manner, without having to invert the tank. Further, the pressure relief valve (not shown) may be a safety valve having conventional overpressure protection. The safety valve may open once the internal pressure in the tank 12 exceeds a predetermined safety threshold.

The sprayer 10 includes a liquid delivery system 68 for withdrawing liquid from the tank 12. In the illustrated embodiment, the liquid delivery system 68 includes a fitting extending from the interior to the exterior of the tank 12. More specifically, a brass hose fitting 28 is fitted through the top of the tank 12. The fitting 28 defines a liquid outlet orifice 26 and includes seals, such as VITON® seals, for creating a leak-tight interface between the fitting 28 and the tank 12. The liquid delivery system 68 also includes a liquid withdrawal tube 30 having an apex (not shown) that is inserted into outlet orifice 26 and a base 76 that is located near the bottom of tank 12, so as to be below the liquid level in the tank during normal operation. The liquid delivery system 68 also includes a segment of industrial grade rubber hose 38 connected between the fitting 28 and the flow controller 42 (described below). The hose 38 transports liquid from the fitting 28 to the flow controller 42.

In some applications, the liquid delivery system 68 may also include a valve (not shown), such as a needle or pinch valve, for controlling the flow of liquid from the tank 12. This valve would typically be inserted between brass fitting 28 and the liquid delivery hose 38 or at any location along the liquid delivery hose 38. This has the effect of allowing a wider range of operating conditions for the spray unit. Providing a flow constriction in the liquid line can reduce liquid consumption, while at the same time producing a foam with higher air content/expansion ratio.

The sprayer 10 also includes an air delivery system 70 for withdrawing air from the tank 12. In the illustrated embodiment, the air delivery system 70 includes a fitting extending from the interior to the exterior of the tank 12. More specifically, a brass hose fitting 34 is fitted through the top of the tank 12. The fitting 34 defines an air outlet orifice 32 and includes seals, such as VITON® seals, for creating a leak-tight interface between the fitting 34 and the tank 12. In this embodiment, the air control valve is a conventional needle control valve 36. The needle control valve 36 is mounted within brass fitting 34, and may be constructed from polypropylene (PP) or polyvinylchloride (PVC). The needle control valve 36 may be replaced by other valves, such as a pinch valve, and may be moved to other locations along the air path, for example, to essentially any location from within the tank to the mixing chamber. The air delivery system 70 also includes a segment of industrial grade rubber hose 40 connected between the fitting 34 and the flow controller 42 (described below). The hose 40 transports air from the fitting 34 to the flow controller 42. The air delivery system 70 may also include a check valve 44 to prevent the backflow of spray liquid through the air delivery system 70. The check valve 44 may be located at essentially any location upstream from the mixing chamber 72 and downstream from the headspace. For example, the check valve 44 may be located anywhere along the air delivery system flow path, such as in fitting 34 or along hose 40. In the illustrated embodiment, the check valve 44 is located along hose 40 near the flow controller 42.

In the embodiment shown in FIGS. 1, 2, 4a, and 5a, the two hose segments 38 and 40 are coiled and bound, side-by-side, in order to facilitate storage and to be less intrusive during operation. The precise configuration of the hose segments 38 and 40 may, however, vary from application to application. For example, the two hose segments 38 and 40 need not be connected in a side-by-side configuration, but may be separate from one another or coaxial with one another, as desired.

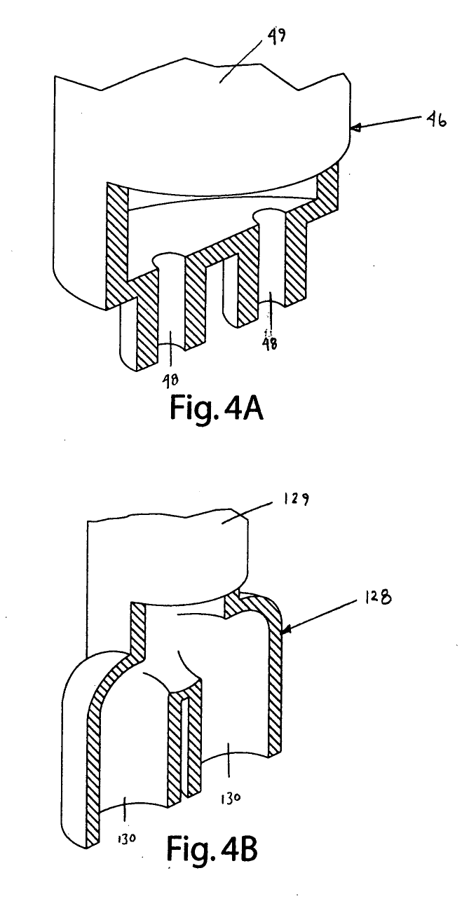

FIG. 4a shows an enlarged perspective view of the segregated side-by-side entry into the mixing chamber 72. The flow controller 42 includes a fitting 46 that has two inlet orifices 48 to accommodate the two hose segments 38 and 40. The exit orifice 49 of fitting 46 may be either attached to the base 43 of the flow controller 42, or it may be disposed in other locations.

In an alternate embodiment, a flow insert (not shown) may be used to effect the transition from a segregated, side-by-side delivery system to a segregated, co-axial delivery system. In this case, a coaxial fitting (not shown) accommodates the attachment of transport hoses 38 and 40 and attaches to the base 43 of the flow controller 42. The axisymmetric entry of the two fluids into the mixing chamber 72 may have the practical effect of enhancing the consistency of the produced foam.

Although the illustrated embodiment includes conventional commercial grade rubber hoses, the air delivery line 40 and liquid delivery line 38 may be varied in composition. The optimum hose selection will be application-specific and include considerations such as pressure rating, flexibility, cost, and resistance to chemicals. Some examples of alternate hose material include ethylene-propylene-diene monomer (EPDM), Hypalon, PVC, and Teflon®.

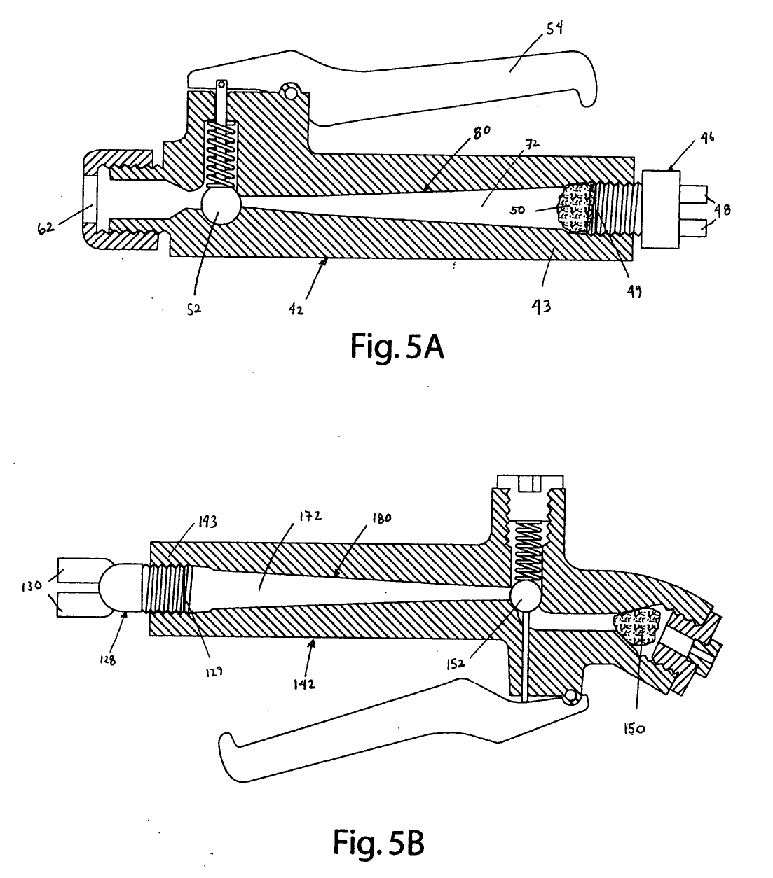

As noted above, the spray unit 10 includes a flow controller for selectively controlling the spray of effluent. FIG. 5a shows an enlarged, cross-sectional view of the chemical-resistant Poly flow controller 42 (see also FIG. 2). The internal structure shown in FIG. 5a is merely representative, and the actual structure may vary. The flow controller 42 generally includes a hollow body 80 defining an interior flow path, a mixing chamber 72 for mixing the air and liquid, and a valve 52 for controlling the flow of effluent from the sprayer 10. The illustrated flow controller 42 is available from Root-Lowell Manufacturing Co., Lowell, Mich. In this embodiment, the mixing chamber 72 is defined by the entry region of the flow controller 42. A mixing medium 50 may be disposed in the mixing chamber 72 to facilitate mixing of the air and liquid. The mixing medium 50 may be a small section of Scotch-Brite 8440 (available from 3M, Minneapolis, Minn.), and is typically a rectangular segment in the size range of 1″×½″. Spray exiting from the mixing chamber 72 is regulated by valve 52 and is actuated by the user with handle 54. Handle 54 may be held in the “open” position via the locking mechanism (not shown). Handle 54 may also be held in the “closed” position in order to prevent accidental spraying via the locking mechanism (not shown). A chemical-resistant spray wand 60 is attached and sealed to the exit orifice 62 of the flow controller 42. Affixed to the outlet orifice (not shown) of the spray wand 60 is the adjustable nozzle 64. The spray nozzle 64 may be varied in geometry to produce different pressure drop-flow rate characteristics and/or spray patterns. Typical nozzles deliver flow rates of 0.05 to 0.30 liquid gpm with pressure drops of 20 psi. Desirable spray patterns vary with application, but may include: a straight stream, a conical mist, or a fan pattern.

The mixing medium 50 may be composed of different material, such as stainless steel wool. This would be appropriate when trying to increase the useful life of the mixing medium 50 prior to replacement, or when the spray fluid is relatively corrosive. The mixing medium 50 may also be varied in construction, having, for example, different mesh densities or mesh fiber sizes. This can have the effect of tailoring the resulting foam properties, according to the desired application, by varying, for instance, the foam consistency, foam expansion ratio, and/or foam bubble size distribution. In some applications, the mixing medium 50 may be disposed as a location downstream of the mixing chamber 72, or even entirely absent.

The specific materials used to construct the various components of the sprayer 10 may vary from application to application. For example, the flow controller 42, delivery hoses 38 and 40, spray wand 60, and/or nozzle 64 may be composed of brass. This increases the strength and corrosion resistance of the part(s), as may be dictated by the particular application.

The procedure for the application of a foam spray begins with the remov,al of the pump assembly 74 from the tank 12 by turning it counter-clockwise. This allows the tank 12 to be filled with the appropriate spray liquid. The maximum fill line (not shown) for the fluid in the tank is marked on the exterior of the tank and is generally one-half of the tank capacity. Less spray liquid may be used, depending on the size of the target area of application. After filling, the pump assembly 74 is reinserted into the tank and rotated clockwise until sealed. The pump handle 18 is then operated in upward and downward strokes repetitively until the appropriate head pressure is achieved (˜20 to 30 psi).

The spray is applied by depressing the handle 54 on the flow controller 42. This allows the air and liquid streams to exit the tank 12 and travel in a segregated fashion to the mixing chamber 72 of the flow controller 42, and to be expelled via the nozzle 64. In the default configuration, the needle valve 36 is open, and the resulting air/liquid mixture passing through the mixing medium 50 generates a spray foam, whose characteristics depend on the pressure in the headspace of tank 12, the flow rates of the air and liquid streams, the precise nature of the mixing medium 50, and the chemical composition of the spray liquid. The flow rate of air into the mixing chamber 72 can be selectively controlled by operation of the needle valve 36. This in turn varies the composition of the foam effluent. For example, less air will typically give the effluent a more fluidic character while more air will typically give the effluent a more foamy character. When the needle valve 36 is completely closed, no foam forms, and a conventional liquid spray issues from the spray nozzle 64. In practice, there will be an optimal setting for the valve for the creation of foam, given the chemical nature of the spray liquid.

### Alternative Embodiment

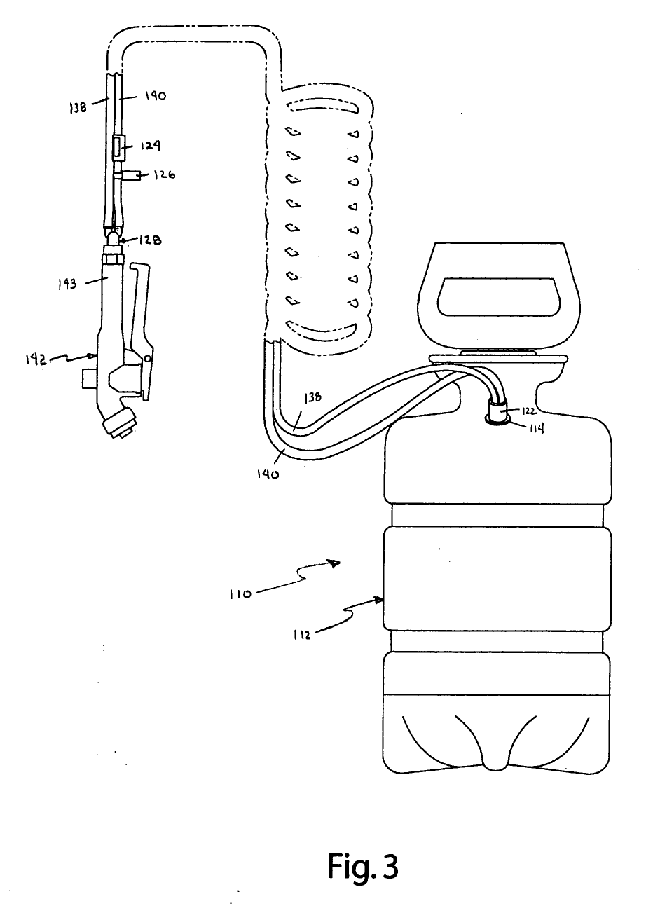

An alternative embodiment of a hand-operated, portable sprayer capable of producing a foam spray is shown in FIGS. 3, 4b, and 5b, and is designated generally as 110. Many of the underlying principles and structural descriptions of the alternative embodiment are similar to those described above for the preferred embodiment. As such, only the salient differences between the two are described here.

In this embodiment, tank 112 of sprayer 110 has only one outlet fitting 114. The outlet fitting 114 is generally composed of plastic, but may be made of other material as well. A plug, such as rubber stopper (not shown), defining two holes, namely the air exit orifice (not shown) and the liquid exit orifice (not shown), is affixed to the outlet fitting 114 in an air-tight fashion. For example, the rubber stopper (not shown) may be secured in a conventional manner with a plastic screw cap 122. An air transport hose 140 is inserted into to the tank 112 via the air exit orifice (not shown) and penetrates only into the headspace of the tank 112. Similarly, a liquid transport hose 138 is inserted into to the tank 112 via the air exit orifice (not shown) and penetrates into the bottom, liquid-containing portion of the tank 112.

The air transport hose 140 has two control valves along its length. Check valve 124 prevents a backflow of spray liquid through the air transport hose 140. The flow control valve 126 is typically a pinch valve, used for the regulation of the air flow rate. In the embodiment shown, the valves 124 and 126 are depicted as being situated near the flow controller 142. If desired, the valves 124 and 125 can alternatively be situated essentially anywhere upstream from the mixing chamber and downstream from the headspace, for example, at essentially any location along the length of air transport hose 140.

A Y-fitting 128, which is connected to the liquid and air transport hoses 138 and 140, is shown in FIG. 4b. The Y-fitting has two inlet snap-fit portions 130 that receive transport hoses 138 and 140 in a leak-tight manner. The Y-fitting may include alternative hose attachment structure as desired, such as a friction fitting or a compression fitting. In this embodiment, the Y-fitting 128 defmes two internal flow passages that merge together to define a mixing chamber 172.

The outlet orifice 129 of the Y-fitting 128 attaches to the base 143 of the flow controller 142, as illustrated in FIG. 5b. The internal structure shown in FIG. 5b is merely representative, and the actual structure may vary. The flow controller 142 generally includes a hollow body 180 defining an interior flow path, and a valve 152 for controlling the flow of effluent from the sprayer 110. In this embodiment, a mixing medium 150 may be disposed in the body 180 to facilitate mixing of the air and liquid. A nozzle 164 may be mounted to the outlet of the flow controller 142. In this embodiment, the nozzle 164 is threadedly secured within the outlet and the mixing medium 150 is disposed within the body 180 immediately upstream from the nozzle 164. At this location, the mixing medium 150 provides optimal foaming for many applications, and is easily installed by placing it into the body 180 before installing the nozzle 164.

The above description is that of the preferred embodiment of the invention. Various alterations and changes can be made without departing from the spirit and broader aspects of the invention as defined in the appended claims, which are to be interpreted in accordance with the principles of patent law, including the doctrine of equivalents. Any reference to claim elements in the singular, for example, using the articles “a,” “an,” “the,” or “said” is not to be construed as limiting the element to the singular.

The embodiments of the invention in which an exclusive property or privilege is claimed are defined as follows:

1. A hand-operated, portable sprayer comprising:
a tank;
a flow controller;
a pump assembly for pressurizing said tank;
an air delivery system connected to said tank and said flow controller, whereby pressurized air flows from the headspace in said tank to said flow controller; and
a liquid delivery system connected to said tank and said flow controller, whereby liquid flows from said tank to said flow controller, wherein said liquid delivery system is segregated from said air delivery system such that the liquid is withdrawn from said tank segregated from the air.

2. The hand-operated, portable sprayer of claim 1, wherein said pump assembly includes a hand pump for pressurizing the air in the headspace of said tank.

3. The hand-operated, portable sprayer of claim 1, wherein an air control valve is located between said tank and said flow controller along said air delivery system.

4. The hand-operated, portable sprayer of claim 3, wherein said air control valve comprises a needle valve.

5. The hand-operated, portable sprayer of claim 3, wherein said air control valve comprises a pinch valve.

6. The hand-operated, portable sprayer of claim 1, wherein a liquid control valve is located between said tank and said flow controller along said liquid delivery system.

7. The hand-operated, portable sprayer of claim 6, wherein said liquid control valve comprises a needle valve.

8. The hand-operated, portable sprayer of claim 6, wherein said liquid control valve comprises a pinch valve.

9. The hand-operated, portable sprayer of claim 1, wherein the exterior surface of said tank contains an inlet orifice for an external feed line.

10. The hand-operated, portable sprayer of claim 1, wherein the exterior surface of said tank contains a pressure release valve.

11. The hand-operated, portable sprayer of claim 1, wherein said air delivery system comprises an exit orifice located on the headspace portion of said tank, which is connected to an air transport system.

12. The hand-operated, portable sprayer of claim 1, wherein said liquid delivery system comprises a withdrawal tube inserted into said tank through an exit orifice, in which one end of said withdrawal tube is connected to a liquid transport system and the other penetrates the interior of said tank to near the bottom of said tank.

13. The hand-operated, portable sprayer of claim 1, wherein said liquid delivery system comprises an exit orifice located near the bottom of said tank, which is connected to a liquid transport system.

14. The hand-operated, portable sprayer of claim 1, wherein said liquid delivery system comprises an exit orifice located on said tank and a flexible hose penetrating through said orifice into said tank, whereby liquid is transported to said flow controller.

15. The hand-operated, portable sprayer of claim 11, wherein said air transport system comprises a flexible hose, whereby air is transported to said flow controller.

16. The hand-operated, portable sprayer of claim 12, wherein said liquid transport system comprises a flexible hose, whereby liquid is transported to said flow controller.

17. The hand-operated, portable sprayer of claim 1, wherein said air and liquid delivery systems are arranged substantially side-by-side.

18. The hand-operated, portable sprayer of claim 1, wherein said air and liquid delivery systems are arranged substantially coaxially.

19. The hand-operated, portable sprayer of claim 1, wherein said sprayer contains a mixing medium inserted into the fluid flow path.

20. The hand-operated, portable sprayer of claim 19, wherein said mixing medium comprises a fibrous mesh.

21. A hand-operated, portable sprayer comprising:
a sealed, pressure-resistant tank having a pump assembly inserted into sand tank, said pump assembly supplying air to said tank to pressurize a headspace defined within said tank;
a liquid withdrawal tube extending into and near a bottom of said tank;
a liquid transport hose connected in fluid communication with said liquid withdrawal tube;
an air transport hose connected in fluid communication with said headspace;
a flow controller attached in communication with said air transport hose and said liquid transport hose, said flow controller having a valve for selectively controlling flow of effluent from the sprayer.

22. The sprayer of claim 21 wherein said flow controller defines a mixing chamber in communication with said air transport hose and said liquid transport hose, wherein liquid delivered by said liquid transport hose is merged with air delivered by said air transport hose.

23. The sprayer of claim 21 further comprising a fitting connected between said flow controller to said air transport hose and said liquid transport hose, said fitting defining a mixing chamber, wherein liquid delivered by said liquid transport hose is merged with air delivered by said air transport hose.

24. The sprayer of claim 22 further comprising a mixing medium disposed within or downstream from said mixing chamber.

25. The sprayer of claim 23 further comprising a mixing medium disposed within or downstream from said mixing chamber.

26. A portable sprayer comprising:
a tank;
a mixing chamber separate from said tank;
an air delivery system in fluid communication with said tank and said mixing chamber;
a liquid delivery system in fluid communication with said tank and said mixing chamber, said liquid delivery system being segregated from said air delivery system such that air and liquid are separately delivered from said tank to said mixing chamber, wherein said mixing chamber combines air from said air delivery system and liquid from said liquid delivery system to generate a foam; and
a flow controller in fluid communication with said mixing chamber for controlling a flow of foam from the sprayer.

27. The sprayer of claim 26 further comprising a mixing media located within or downstream from said mixing chamber.

28. The sprayer of claim 27 further comprising a nozzle mounted to an outlet of said flow controller, said mixing media being disposed immediately upstream from said nozzle.
